(19) United States
(12) Patent Application Publication
(10) Pub. No.: US 2018/0082606 A1
(43) Pub. Date: Mar. 22, 2018

(54) APPARATUS TO DETECT, ANALYZE, RECORD, AND DISPLAY AUDIO DATA, AND METHOD THEREOF

(71) Applicant: Lawrence Jones, Woburn, MA (US)

(72) Inventor: Lawrence Jones, Woburn, MA (US)

(21) Appl. No.: 15/810,559

(22) Filed: Nov. 13, 2017

Related U.S. Application Data
(60) Provisional application No. 62/394,123, filed on Sep. 13, 2016.

(51) Int. Cl. G09B 15/00; G06F 17/30; G10H 1/057; G09B 15/04; G09B 15/08

(52) U.S. Cl. CPC G09B 15/003; G06F 17/30746; G09B 15/006; G10H 1/0575; G10H 2230/155; G09B 15/04; G09B 15/08; G10H 2210/385; G10H 2240/281; G09B 15/008

(57) ABSTRACT

An apparatus to detect, analyze, record, and display audio data, including an input unit to allow a user to input musical notes corresponding to the audio data, a processor to analyze the musical notes and to save the musical notes into a file, and a display unit to display notes corresponding to the musical notes on a virtual instrument.

### CROSS-REFERENCE TO RELATED APPLICATIONS

This application claims priority under 35 USC §119(e) from U.S. Provisional Application No. 62/394,123, filed on Sep. 13, 2016, in the United Stated Patent and Trademark Office, the disclosure of which is incorporated herein in its entirety by reference.

### BACKGROUND OF THE INVENTION

### 1. Field of the Invention

The present general inventive concept relates to an apparatus to detect, analyze, record, and display audio data, and a method thereof.

### 2. Description of the Related Art

Many devices have been developed to analyze music in some fashion. Such devices include electronic devices that provide training and feedback to users. Examples of such devices include electronic applications that play music and prompt users to repeat the played music or identify the note(s) making up the musical sound. An example of such an application is the KARAJAN music and ear trainer application. Many games also incorporate music analysis at some level. For example, the GUITAR HERO video game (and like video games) challenge users to provide proper inputs corresponding to music, which are scored as part of the game. Other applications have been geared to analyze music for the purpose of identifying songs, such as the SHAZAM audio application, which identifies songs based on audio fingerprinting of song segments.

Conventionally, applications for musical training and gaming devices are limited to proprietary inputs means (e.g., proprietary input devices used with a game console) or to handling digital audio formats. This limits these devices to use with specific hardware or on-device analysis of digital audio formats. Song identification applications tend to be limited to somewhat lengthy music segments and are essentially employed only to identify captured audio.

Furthermore, learning to play a musical instrument requires a great deal of time, dedication and practice. Musicians learn how an instrument works and the instrument's various methods to generate notes, chords and scales. Although some musicians can play musical instruments by ear, other musicians learn to read musical notation or sheet music and play the notes and chords on the sheet music to generate a particular song. Many musicians practice playing a particular song until their playing is proficient or they reach a different personal goal such as adding his or her own artistic flare to a particular song.

As a musician grows and becomes more interested in a particular genre of music such as jazz, classical, rock and roll and/or country, the musician may wish to learn different solos or musical compositions of the greatest musical artists of that genre. For example, in the jazz and rock genres, a key goal is to be able to play the solos of the greats (e.g. Eddie Van Halen, Steve Vai, Slash in Rock or Wes Montgomery, George Benson, Charlie Christian, Jim Hall in jazz). However, in many cases such solos are difficult to learn with or without a teacher due the complexity of the music, the speed of the song and speed of the lick i.e. stock pattern or phrase.

Additionally, the musician lacks a tool to objectively compare his or her performance with an original audio file or any other rendering of the song. If both recordings and data files can objectively be evaluated or compared, then the musician could more easily identify the portions that he or she may not be hearing properly due to a factor such as the speed of the licks.

Another problem impeding both the self-taught and teachers taught musicians is the break in practice sessions and loss of memory that occurs when a musician starts and stops practicing and new song. For example, a musician may work on a song or solo and learn a portion of it, but be unable to further work on the song for some time. When the musician attempts to work on the piece again, the musician may forget everything that he or she previously learned and be forced to start from the beginning and relearn everything that the musician previously learned. The same situation may occur when a student has a weekly music lesson with a teacher, returns for the next weekly session, and then either the teacher or student or both forget portions of the previous lesson.

Conventional applications and software have features to assist musicians learn new music selections by allowing them to manually transcribe music. For example, Amazing Slow Downer can increase or decrease the music playing speed, adjust tone and make pitch adjustments; Transcribe (from Seventh String) which does not actually transcribe music but provides the user with assistance in discerning musical features with their own ears; and Guitar Pro (for the 105 environment to support slowing down the music while maintaining its original pitch).

Although the conventional apps and software noted above attempt to assist users and musicians master new musical selections, none of the programs solve the problems of musician being forced to repeat previous practice or transcription sessions due to a loss of memory of the previous practice session. Additionally, none of the programs are able to provide a higher level of assistance and cannot compare the musician's actual song or solo with the original audio track.

Moreover, there is no program or application in existence that provides a transcribed track that represents a portion of music, e.g., a guitar solo, which has been manually transcribed or recorded by the user, such that it may be heard as an overlay to the original track. Thus, there is no program in existence that allows the user to record the transcription of the solo or different parts of the solo and begin from where the/she hey left off, if some time is needed between working out and competing the entire solo.

Therefore, there is a need for a program that simplifies the act of writing down audio information taken from a music CD, audio file, or the like (a.k.a., music transcription), and allows a user to save portions of music that has been transcribed.

Since the act of writing down audio information taken from a music CD or the like, which is called music transcription, can be done only by people having musical knowledge and special capabilities such as perfect pitch, it has long been studied to have a computer or the like do the work.

One factor that makes it difficult to transcribe music automatically by a computer is overtones of a note produced by a musical instrument.

When a single note is produced by a musical instrument, the frequencies of the fundamental note (fundamental wave) and a plurality of overtones (harmonics) corresponding to the degree of highness (pitch) of the sound are generated at the same time. Although the overtone frequencies are usually integer multiples of the fundamental note, it is known that the frequencies of high-order overtones of the piano are not integer multiples of the fundamental note.

The ratio of the power of each overtone to the power of the fundamental note depends on the musical instrument. Even in the same musical instrument, the power ratio varies with the pitch of the sound and with time after the key is depressed or the sound is produced. Strictly speaking, each produced sound has a different power ratio, depending on the way the key is touched or the way the sound is produced (tonguing and the like), even if the same note is made by the same instrument.

The state of a single note is complicated, as described above, and when a plurality of notes are sounded simultaneously, the state becomes even more complicated. If some fundamental notes or overtones of the plurality of the simultaneously produced notes have close frequencies, the powers of the fundamental notes or overtones change because the phases cancel out each other or overlap with each other.

In automatic music transcription, the pitch of an instrumental note is extracted by detecting the frequency of the fundamental note of the instrument. However, because the overtone-to-fundamental power ratio varies with many conditions, it is not easy to judge whether the note is a fundamental note or an overtone. This fact has made it difficult to transcribe music automatically.

One method to eliminate those overtones is disclosed in JP-A-2000-293188, for instance. On the assumption that the power ratio generally depends on the musical instrument, the method disclosed in this reference determines whether a frequency (comparison frequency) higher than a frequency of interest is an overtone of the frequency of interest, and if yes, reduces the sound volume of the comparison frequency by a certain ratio and adds the reduced sound volume to the sound volume of the frequency of interest under certain circumstances.

If the power ratio almost depends on the musical instrument, the method described above would be effective. Actually, many musical instruments have power ratios greatly varying depending on ranges, so that overtones might not be properly eliminated by a certain ratio in some ranges.

The conventional structure reduces the sound volume of the comparison frequency (overtone) by a certain ratio, but the comparison frequency may contain the sound volume of overtones of another note sounding at the same time. The sound volume of the comparison frequency should not be reduced by a certain ratio; instead, the sound volume of the frequency of interest (fundamental note) multiplied by a ratio depending on the order of the overtone of the comparison frequency should be reduced from the sound volume of the comparison frequency.

### SUMMARY

The present general inventive concept provides an apparatus to detect, analyze, record, and display audio data, and a method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an apparatus to detect, analyze, record, and display audio data, including an input unit to allow a user to input musical notes corresponding to the audio data, a processor to analyze the musical notes and to save the musical notes into a file, and a display unit to display notes corresponding to the musical notes on a virtual instrument.

The display unit may display a virtual piano roll to allow the user to input the musical notes using the input unit.

The file may be at least one of a midi file and a musicXML file.

The foregoing and/or other features and utilities of the present general inventive concept may also be achieved by providing an apparatus to allow a user to transcribe music from an audio file, the apparatus including a processor to play music corresponding to the audio file, a display unit to display a visualization of the music as a playable visual audio track, and an input unit to allow a user to input musical notes to be displayed on the display unit corresponding to the music as a playable visual transcription track.

The processor may change the speed of the played music based on a preference of the user.

The processor may play the playable visual audio track and the playable visual transcription track simultaneously at an original speed.

The musical notes may be input at a slower speed and a synchronization of the music played with respect to the playable audio track at a normal speed is maintained.

The foregoing and/or other features and utilities of the present general inventive concept may also be achieved by providing a method of detecting, analyzing, recording, and displaying audio data, the method including analyzing data input into an input unit using a processor, saving the analyzed data, and displaying musical notes corresponding to the analyzed data on a virtual instrument.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates an apparatus to detect, analyze, and display audio input data, according to an exemplary embodiment of the present general inventive concept;

FIG. 2 illustrates a screen on the display unit displaying an audio track and a transcription track, according to an exemplary embodiment of the present general inventive concept;

FIG. 3 illustrates a screen on the display unit displaying a virtual guitar fret (a.k.a., virtual guitar) and a treble clef, according to an exemplary embodiment of the present general inventive concept;

FIG. 4A illustrates a virtual guitar fret displayed on the display unit in a first position with a Low E string on top, according to an exemplary embodiment of the present general inventive concept;

FIG. 4B illustrates another virtual guitar fret displayed on the display unit in a second position with a High E string on top, according to an exemplary embodiment of the present general inventive concept;

FIG. 4C illustrates a virtual guitar fret displayed on the display unit in a third position with a Low E string on top, according to an exemplary embodiment of the present general inventive concept;

FIG. 4D illustrates another virtual guitar fret displayed on the display unit in a fourth position with a High E string on top, according to an exemplary embodiment of the present general inventive concept;

FIG. 5 illustrates a D-chord depicted on the virtual guitar fret as displayed on the display unit 110, according to an exemplary embodiment of the present general inventive concept;

FIG. 6 illustrates a musical representation of a G-major scale on a treble clef, according to an exemplary embodiment of the present general inventive concept;

FIG. 7A illustrates a G-major scale depicted on a virtual guitar fret in a first position, according to an exemplary embodiment of the present general inventive concept;

FIG. 7B illustrates a G-major scale depicted on a virtual guitar fret in a second position, according to an exemplary embodiment of the present general inventive concept;

FIG. 8 illustrates an example of a visualization of virtual piano roll that may be displayed on the display unit, according to another exemplary embodiment of the present general inventive concept;

FIG. 9 illustrates an example of a visualization of a virtual saxophone that may be displayed on the display unit, according to another exemplary embodiment of the present general inventive concept;

FIG. 10 illustrates an example of a visualization of a virtual drum that may be displayed on the display unit, according to another exemplary embodiment of the present general inventive concept; and

FIG. 11 illustrates the apparatus in communication with a mobile device, according to another exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

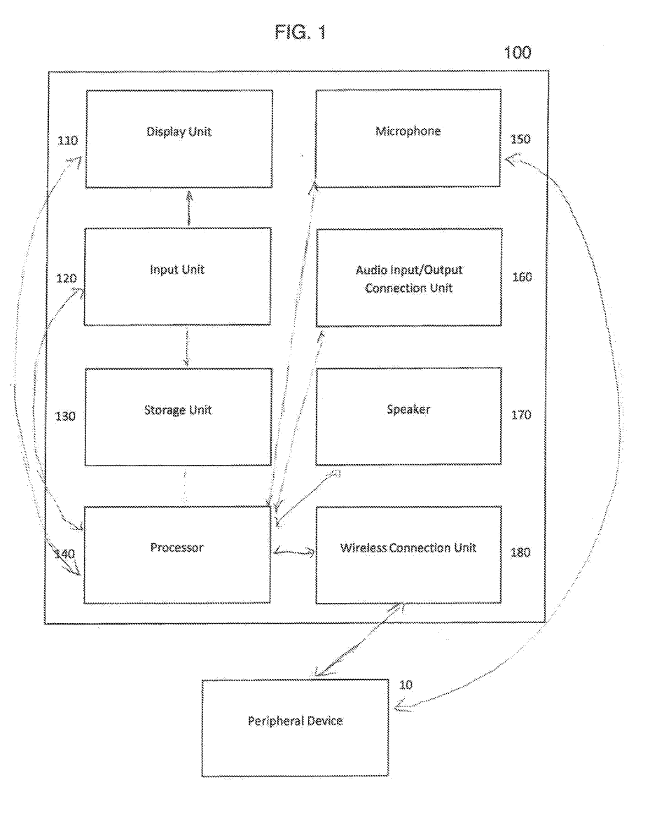

FIG. 1 illustrates an apparatus 100 to detect, analyze, record, and display audio input data, according to an exemplary embodiment of the present general inventive concept.

The apparatus 100 may interact with a peripheral device 10, which may include at least a guitar, an electronic keyboard, a violin, any other type of electronically connectable or non electrically-connectable instrument, an MP3 player, a CD player, a television, a mobile device, and a computer, but is not limited thereto. In other words, the peripheral device 10 may include any type of device that may be connected to the apparatus via electrical, wired, wireless, or aural connection.

Referring to FIG. 1, the apparatus 100 may be a computer, mobile device, video game system, or any other type of non-transitory computer readable medium, but is not limited thereto. The apparatus 100 may include a display unit 110, an input unit 120, a storage unit 130, a processor 140, a microphone 150, an audio input/output connection unit 160, a speaker 170, and a wireless connection unit 180.

The display unit 110 may include a screen to display pictures, videos, and programs thereon, and may include any type of visual displaying technology, including Cathode ray tube display (CRT), Light-emitting diode display (LED), Electroluminescent display (ELD), Electronic paper, E Ink, Plasma display panel (PDP), Liquid crystal display (LCD), High-Performance Addressing display (H PA), Thin-film transistor display (TFT), Organic light-emitting diode display (OLED), Surface-conduction electron-emitter display (SED) (experimental), Field emission display (FED) (experimental), Laser TV (forthcoming), Carbon nanotubes (experimental), Quantum dot display (experimental), Interferometric modulator display (IMOD), Digital microshutter display (DMS), and hologram, but is not limited thereto.

The input unit 120 may allow a user to input commands into the apparatus 100, and may include any type of inputting technology or combination thereof, including a Keyboard, an Image scanner, a Microphone, a Pointing device, a Graphics tablet, a Joystick, a Light pen, a Mouse, a Pointing stick, a Touchpad, a Touchscreen, a Trackball, a Midi player, and a webcam, but is not limited thereto.

The user may use the input unit 120 to open a software application to allow an audio file to be opened, converted, and displayed.

The input unit 120 may also be used by the user when the user is using the software application, to manually input notes corresponding to an audio file being played, in order to transcribe the notes. More specifically, the software application may allow the user to slow down the audio file being played, so that the user may use the input unit 120 to manually transcribe the notes being played.

The storage unit 130 may include various types of storage devices to store programs, files, and other data, including magnetic storage devices such as a Floppy diskette, a Hard drive, a Magnetic strip, a SuperDisk, a Tape cassette, and a Zip diskette, optical storage devices such as a Blu-Ray disc, a CD-ROM disc, a CD-R and CD-RW disc, and a DVD-R, DVD+ R, DVD-RW, and DVD+ RW disc, Flash memory devices such as a Jump drive or flash drive, a Memory card, a Memory stick, or an SSD, or Online storage such as cloud storage and network media, but is not limited thereto.

The processor 140 may perform various processing functions, including downloading files, software, and programs, running programs and software, opening files, playing files, storing data into the storage unit 130, interpreting information from other hardware in the apparatus 100, hardware, making appropriate services available to other parts of the apparatus 100, displaying user interfaces on the display 110, and interpreting the user input from the input unit 120.

The user may run a program or software that allows a media file such as an MP3 or MP4 to play on the apparatus 100. Furthermore, the processor 140 may run a program or software that allows the media file to be captured, interpreted, analyzed, converted, played back as a different type of file, and displayed as a different type of file on the display 110.

The microphone 150 may allow music and sounds to be input via sound-waves and/or audible sounds emanating from the peripheral device 10, such that the music and sounds may be sensed by the microphone 150 to allow software running on the processor 140 to interpret and/or record the music and sounds. More specifically, when the peripheral device 10 is a guitar, for example, the microphone 150 may pick up sounds of the strings as they are played, such that the processor 140 may record the sounds to be saved in an audio file. Also, the user may speak into the microphone 150 to allow the processor to record the user's voice.

The audio input/output unit connection unit 160 may allow the user to connect an audio jack into the apparatus 100 to allow for either capture or playback of audio. The audio input/output unit connection unit 160 may also allow the user to connect the peripheral device 10 to the apparatus 100.

The speaker 170 may allow the user to hear audio files or any other sounds playing on the apparatus 100. The speaker 170 may be provided singularly or in plurality, in order to output monaural or stereo sound.

The wireless connection unit 180 may support wired or wireless communications with peripheral devices using various wired or wireless technologies, including Universal Serial Bus (USB), Firewire, Bluetooth, ZigBee, Infrared Transmission, Radio Frequency Identification (RFID), Wireless LAN (WLAN), (IEEE 802.11 branded as Wi-Fi and HiperLAN), Wireless Metropolitan Area Networks (WMAN) and (LMDS, WiMAX, and HiperMAN), W-Fi Direct, Hotspots, Microwave, Satellite, 3G, 4G, WiMAX, cellular communication (including 3G, 4G, and beyond 4G), IrDA, TransferJet, Wireless USB, DSRC (Dedicated Short Range Communications), EnOcean, Near Field Communication (NFC), EnOcean, Personal area networks, Ultra-wideband (UWB from WiMedia Alliance), but is not limited thereto.

For example, the apparatus 100 may use peer-to-peer technology, such as Bluetooth pairing, to connect the apparatus 100 wirelessly with the external peripheral device 10, such as an MP3 player, computer, mobile device, etc., such that the software running on the processor 140 may capture and detect music playing on the external peripheral device.

The processor 140 may analyze an audio file or audio captured from the peripheral device 10 by using a software application that may be downloaded and installed on the apparatus 100, to be run by the processor 140. The analysis may include extracting various components of an audio sample, converting the audio sample or the various components of the audio sample into a midi file or various midi files, and then displaying the elements of the midi file as notes on the display 110. More specifically, after the audio sample is converted to the midi file, the processor 140 uses the software application to display notes corresponding to various pitches output by the converted midi file. As a result, the notes output by the midi file may be displayed visually on the display 110 on a treble clef, a bass clef, a virtual guitar fret, a virtual piano keyboard, a virtual saxophone, a virtual flute, a virtual drum, and/or any other instrument supported by the software application.

Therefore, if notes are depicted on the virtual guitar fret displayed on the display unit 110, for example, the user may follow the notes as they are displayed or “lit up,” in order to learn how to play a guitar. In other words, the user can follow along with the notes displayed on the display 110, and simultaneously strum the guitar held by the user with proper chord fingering.

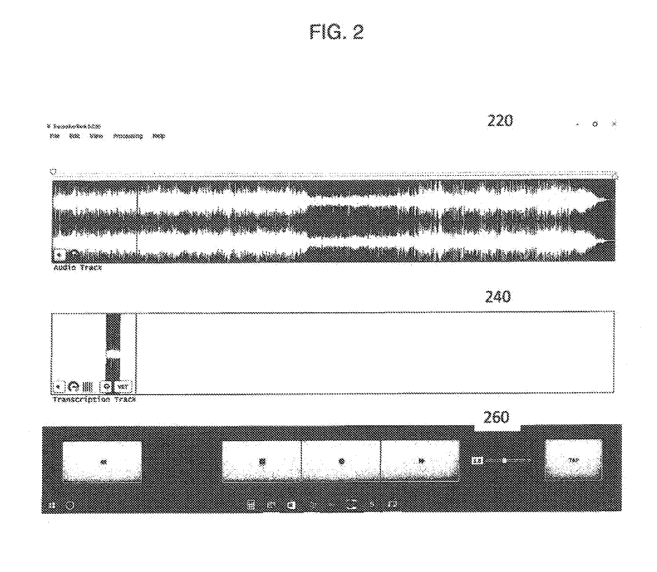

FIG. 2 illustrates a screen on the display unit 110 displaying an audio track 220, a transcription (a.k.a., transcriber) track 240, and a control portion 260, according to another exemplary embodiment of the present general inventive concept.

Referring to FIG. 2, the display unit 110 may display a visual depiction of the audio track 220, which can be a musical audio track of which the user would like to transcribe at least a portion. The display unit 110 may also display a visual depiction of the transcription track 240, denoting a portion of the audio track that has been manually transcribed by the user. More specifically, the user may choose to learn a portion of the audio track 220 that is a particularly difficult guitar solo. As such, the user may choose to only transcribe a portion of the audio track in order to learn the guitar solo portion. The control portion may include buttons to allow the user to control playback of the audio track 220 (e.g., play, stop, pause, fast forward, rewind, record), may include a slide-bar or dial to allow the audio track 220 to be sped-up or slowed-down, and may also include, a button to allow the user to manually “tap” a beat, rhythm, or time signature to obtain beats-per-minute of a particular song, for example. The above audio track 220, transcription track 240, and control portion 260 may all be part of a program or application called “Transcriber Track,” but is not limited to this name.

A unique feature in the transcription track 240 is that it provides a transcribed track that represents a portion of music, e.g., a guitar solo, which has been manually transcribed or recorded by the user, such that it may be heard as an overlay to the original track. Thus, as the song is being worked out and transcribed by the user, the user can record the transcription of the solo or different parts of the solo and begin from where the/she hey left off, if some time is needed between working out and competing the entire solo.

The transcription track 240 can process a particular instrument that the user wants to transcribe with by using either internal effects processing or using a VST interface for commercial effects tools. Moreover, an equalizer (EQ) effect may be provided to process the original audio track to put more emphasis on the frequency range of the instrument being transcribed from the track (e.g. boost a frequency range of a Saxophone during a Sax solo). In effect, the saxophone, for example, will be played at a louder, clearer, and more distinguishable decibel than other non-desired instruments in the background of the audio track 220. Moreover, Transcriber Track can slow down or speed up an audio track (and transcribed track simultaneously and synchronously) so that the user can record the solo overlaid against the original track at a slowed down speed, but yet play it back at the original speed of the track. This will allow a guitarists to transcribe solos of instruments that may be inherently difficult for a guitar to keep up with in real time (e.g. saxophone). The guitarist can play at a slower speed but have it play back overlaid against the original track at the original speed. Using the transcribed track the user can work out one bar or two bars of the solo at a time and come back to it a week later and begin from where he or she left off. Once the transcribed track (or particular phrases of the audio track of interest) is completed, the user can use a pitch detection algorithm to convert the transcribed track to midi or musicXML. Also a tap tempo feature is used to provide the reference timing that the note timing is derived from for the midi and/or musicXML conversion. The midi/musicXML conversion tool comes with correction editing tools to get the pitches just right. Once the transcribed track is converted to midi or musicXML it can be translated into music notation software or played back using guitar fretboard or piano display so that the notes can be illustrated to the user in real time or at a slowed down or accelerated speed using a musicXML player. Transciber track may also contain a musicXML player which displays the notes being played on a guitar fretboard, keyboard, or many other instruments (Saxophone display, flute display, etc . . . ).

To reiterate, “Transcriber Track” is a transcription tool that provides both an audio track to be transcribed (transcribed meaning it contains a solo or chords to be copied and/or written in notation) and a transcriber track which contains the resulting transcription. “Transcriber Track” allows the user to work on the transcription incrementally as the progress of the transcription is retained on the transcription track (which may be recorded corresponding to different regions or bars of the audio track at different sessions). As such, the user does not need to memorize the complete transcription since the progress is retained in the recording.—The transcription track can be recorded while playing against the audio track at original speed (speed of 1) or possibly a slower speed (e.g. half speed of 0.5). When the transcriber track and audio track are sped up to original speed (1), the two tracks will remain synchronized so the whole solo or solo phrases can be recorded at a slower speed. This allows for users to work out solos from instruments (or artists) that are inherently faster than the user is able to play, but hear the solo played back at the original speed. For example, a guitarist can transcribe a sax solo from John Coltrane at half speed but hear it played back at the original track speed.

The audio track can be processed with an equalizer (EQ) to bring out the instrument (e.g. saxophone, guitar, etc.) or instruments that are being transcribed. More specifically, in order to obtain a proper sound quality of an instrument to be transcribed an equalizer can change the pitch and sound quality of the output sound to emulate a particular instrument.

A set of effects may be provided for the instrument recorded on the transcription 240 (e.g. EQ, compression, reverb, damping, etc . . . )

The transcribed track may be converted to midi and/or MusicXML using pitch detection algorithms.

A tap tempo feature is used to provide the reference timing that from which the note timing is extracted. Tap tempo timing may be used since the audio track timing may vary over time or may vary with live recordings of music. Different sections are bars may be tapped at 1/4 note (or different timing) to provide the reference timing over that region. The musicXML file or midi file of the transcribed track can be displayed on a guitar fretboard or piano or any other instrument. The MusicXML guitar fretboard (or other instrument) display can be used to retain the note sequences for those players who are learning to read music notation or would like to have that music documented in tablature display.

The user can market and sell solo transcriptions using transcriber track to provide verification that the transcription is accurate. A forum can be established which provides both free and commercial solo's that can be demonstrated with Transcriber Track.

As such, the present general inventive concept includes an apparatus providing an improved manual music transcription tool.

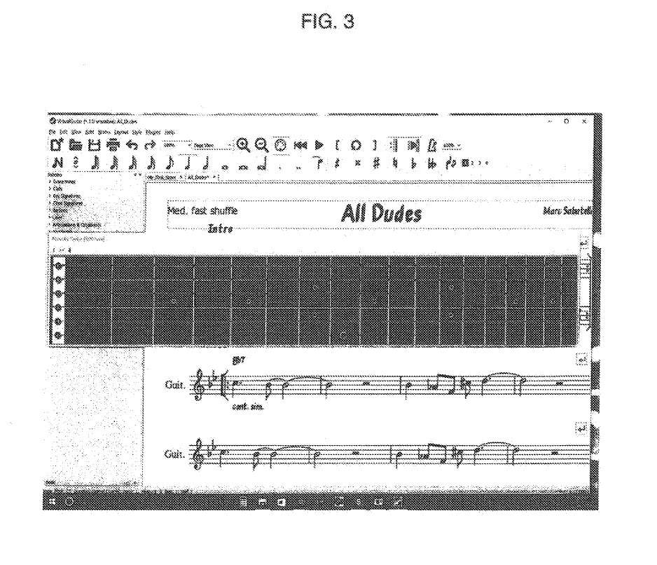

FIG. 3 illustrates a screen on the display unit 110 displaying a virtual guitar fret and a treble clef, according to an exemplary embodiment of the present general inventive concept.

Referring to FIG. 3, notes displayed on the treble clef may be played such that the user can hear the notes being played on the speaker 170. As the notes are being played, the virtual guitar fret may include circles displayed thereon to denote proper strings and fret positions corresponding to the played notes. The circles may be displayed one at a time as the notes are played. Alternatively, the circles may be displayed on the virtual guitar fret simultaneously, such that the circles are filled in with colors as the notes are played.

The user may choose to have the notes played at a slower speed or faster speed, based on the user's preference. More specifically, the notes may be played at a speed dictated by a tempo setting (in beats per minute). If an audio recording is played back, the source audio may not have a consistent beat per minute value, and in this case it may be played back as a fraction of the speed of the original recording, e.g. 70% of the recorded audio speed, or 50% of the recorded audio speed, or 200% of the recorded audio speed, etc.

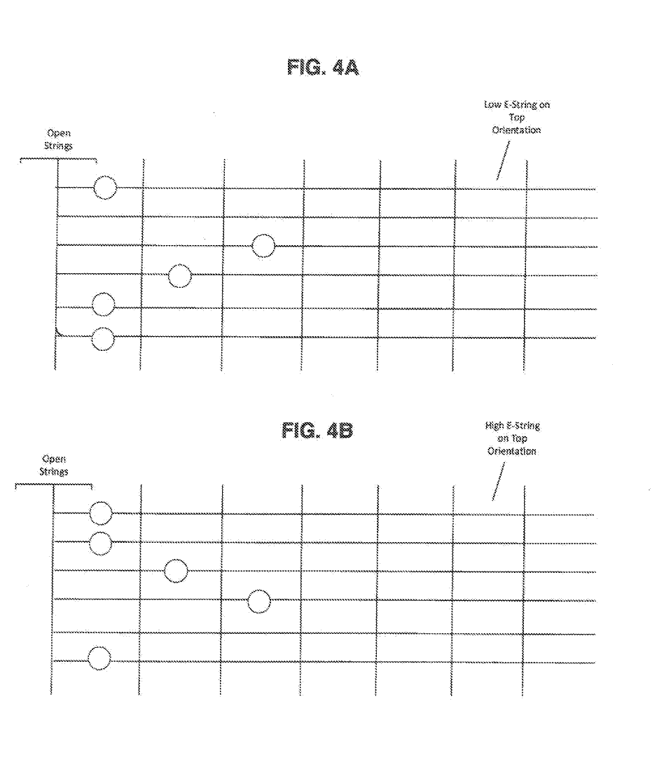

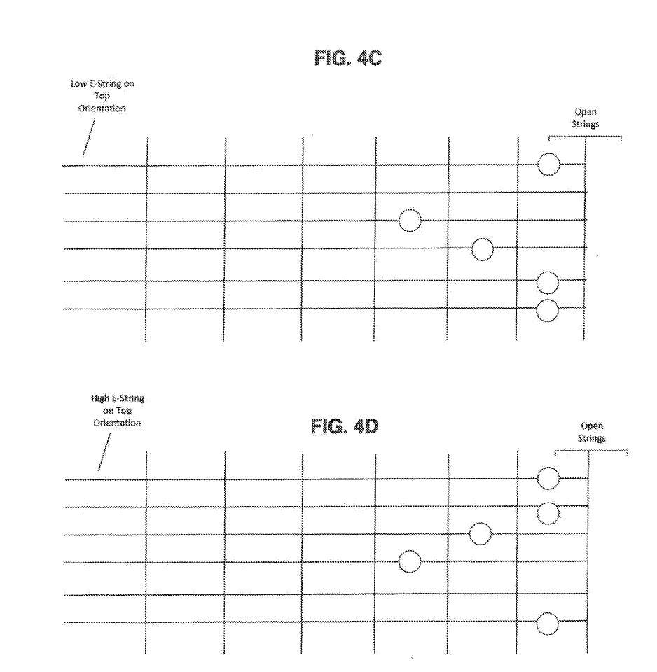

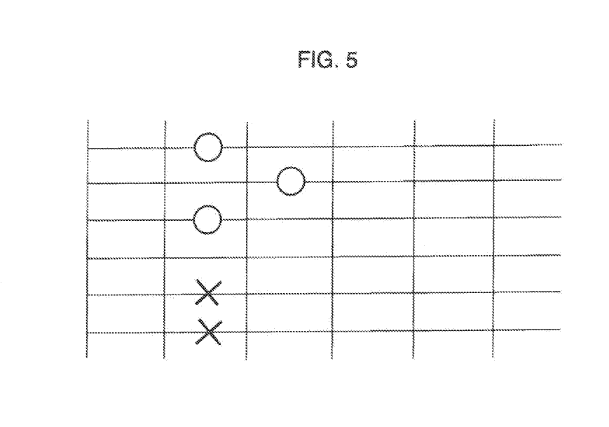

FIG. 4A illustrates a virtual guitar fret displayed on the display unit 110 in a first position with a Low E string on top, according to an exemplary embodiment of the present general inventive concept.

FIG. 4B illustrates another virtual guitar fret displayed on the display unit 110 in a second position with a High E string on top, according to an exemplary embodiment of the present general inventive concept.

FIG. 4C illustrates a virtual guitar fret displayed on the display unit 110 in a third position with a Low E string on top, according to an exemplary embodiment of the present general inventive concept.

FIG. 4D illustrates another virtual guitar fret displayed on the display unit 110 in a fourth position with a High E string on top, according to an exemplary embodiment of the present general inventive concept.

Referring to FIGS. 4A through 4D, when a guitar chord is captured by the software application, such as an F-chord for example, then color-filled circles may be depicted on the guitar fret at their appropriate positions. As such, the user knows that in order to play a proper F-chord, the guitar strings must be pressed at the corresponding positions of the frets, and the strings must be strummed in one motion.

FIG. 5 illustrates a D-chord depicted on the virtual guitar fret as displayed on the display unit 110, according to an exemplary embodiment of the present general inventive concept.

Referring to FIG. 5, when particular guitar strings are not supposed to be played, such as in the case of a D-chord, the low E string and the A string may have an “X” appear thereupon. Alternatively, other methods of denoting a non-played guitar string may be depicted using different colors of the strings or by erasing the strings completely.

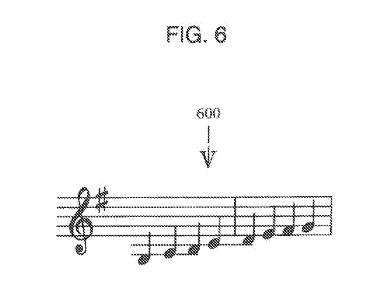

FIG. 6 illustrates a musical representation of a G-major scale 600 on a treble clef, according to an exemplary embodiment of the present general inventive concept.

Referring to FIG. 6, the G-major scale 600 is depicted, including the notes G, A, B, C, D, E, F#, and G. This is an example of notes that may have been transcribed from an audio file converted into a midi file, if the audio file included a guitar solo playing the G-major scale 600.

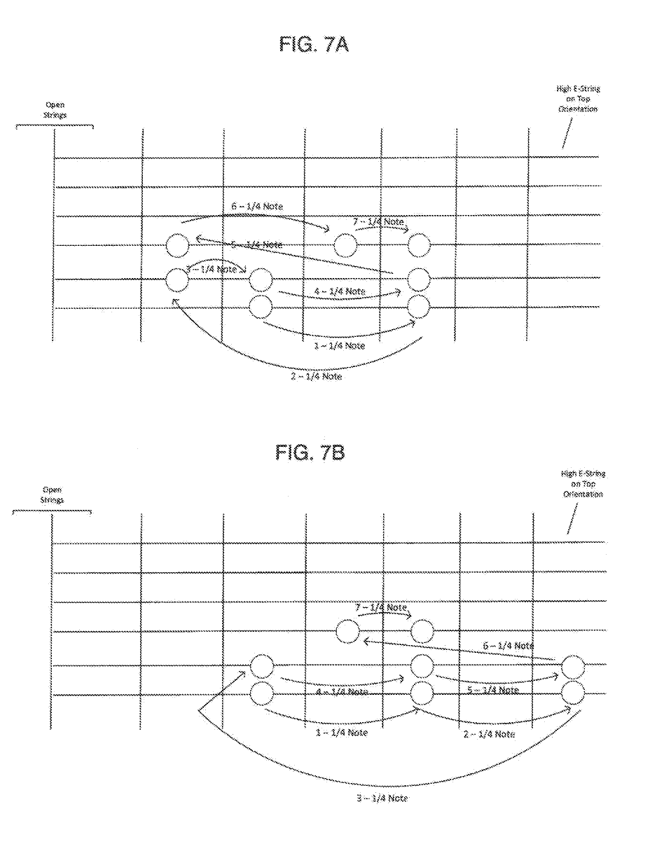

FIG. 7A illustrates a G-major scale depicted on a virtual guitar fret in a first position, according to an exemplary embodiment of the present general inventive concept.

FIG. 7B illustrates a G-major scale depicted on a virtual guitar fret in a second position, according to an exemplary embodiment of the present general inventive concept.

Referring to FIGS. 7A and 7B, when notes are displayed on a virtual guitar fret, circles may be displayed on various strings of the virtual guitar fret to correspond to the notes. For example, if the original audio sample includes eight notes of a G-major scale, including the notes G, A, B, C, D, E, F#, and G, then after conversion of the audio sample to the midi file, eight open circles, i.e., circles that are not filled with a color, may be displayed on the virtual guitar fret. The user may choose to use the software application to play the captured G-major scale displayed on the virtual guitar fret.

Referring to FIGS. 7A and 7B, when the user chooses to use the software application to play the G-major scale, each of the open circles displayed on the virtual guitar fret is filled with a color, i.e., “lit up,” sequentially as illustrated in FIGS. 7A and 7B. More specifically, the circles may be lit up in sequence using a specific color, such as red, blue, green, yellow, black, etc., in order to indicate when and how the strings are supposed to be played. As such, the user can learn how to properly play the G-major scale on a guitar.

More specifically, as illustrated in FIG. 7A, first the circle on the third fret of the E string is lit up, then the circle on the fifth fret of the E string is lit up, then the circle on the second fret of the A string is lit up, then the circle on the third fret of the A string is lit up, then the circle on the fifth fret of the A string is lit up, then the circle on the second fret of the D string is lit up, then the circle on the fourth fret of the D string is lit up, then the circle on the fifth fret of the D string is lit up.

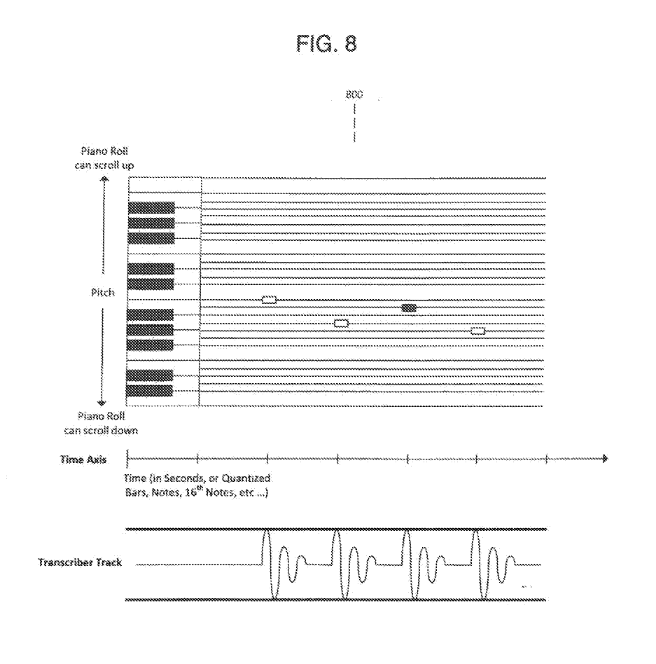

FIG. 8 illustrates an example of a visualization of virtual piano roll 800 that may be displayed on the display unit 110, according to another exemplary embodiment of the present general inventive concept.

Referring to FIGS. 8 and 2, the user may toggle back and forth between the screen of FIG. 2 and the screen of FIG. 8. Alternatively, the virtual piano roll 800 of FIG. 8 may also be displayed on a same screen as the audio track 220, the transcription track 240, and the control portion 260. The user may use the virtual piano roll 800 to find the correct pitch of the notes during manual transcription. The virtual piano roll 800 resembles a real piano, and includes white and black keys that correspond to musical notes. As such, the user may play the audio track 220, then use the keys on the piano roll 800 to transcribe the correct notes corresponding to the music played on the audio track 220. In other words, the user may click (using a mouse) or touch (if the display unit 110 is a touch screen) the white and black keys of the virtual piano roll 800 that correspond with the correct notes as played by the audio track 220. The transcription track 240 then automatically collects the information from the virtual piano roll 800 to include a transcribed portion of music corresponding to the audio track 220. As such, the transcribed portion of music can be saved for use or reference at a later time.

Each of the pitches in the piano roll 800 may be detected by a pitch detection algorithm after running the algorithm using the software including the transcription track 240, which may contain notes played by the user (that attempt to match the notes of a soloist playing music on the captured audio track). Referring to FIG. 8, the detected pitch shown in black is a currently selected value and can be moved (i.e. dragged) up or down the piano roll 800 to a new pitch value or new point in time. The piano roll 800 may used in this manner to manually correct either wrongly identified notes or wrongly located timing by the pitch detection algorithm.

Also, the transcription track 240 can now produce the virtual guitar fret, using musicXML for example, to allow the user to learn how to play the music that was manually transcribed by the user, on a guitar. More specifically, the virtual guitar fret may accept the musicXML produced by the transcription track 240 via an import function, in order to display the virtual guitar fret with the proper notes highlighted corresponding to the music transcribed on the transcription track 240 from the audio track 220.

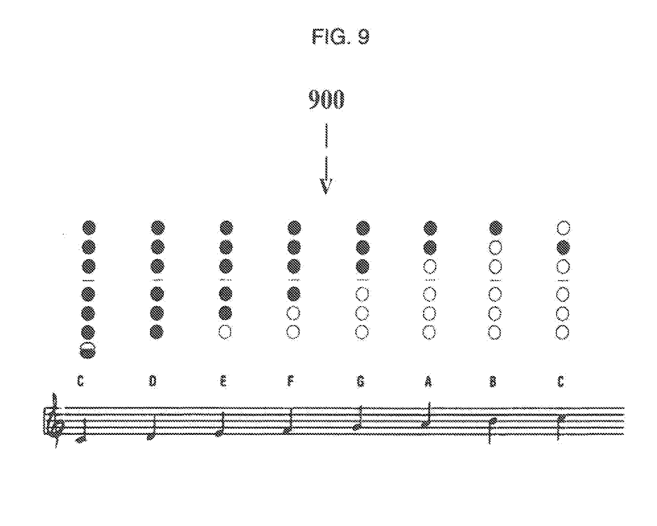

FIG. 9 illustrates an example of a visualization of a virtual saxophone 900 that may be displayed on the display unit 110, according to another exemplary embodiment of the present general inventive concept.

Referring to FIG. 9, the transcriber track 240 can also be used to produce the virtual saxophone 900 to allow the user to learn how to play the music that was manually transcribed by the user, on a saxophone.

More specifically, the virtual saxophone 900 may be displayed with filled dots representing notes to be played by the user. The dots may be filled in real-time, or may be slowed down to allow the user to learn the music at a desired tempo.

Although FIG. 9 displays a virtual saxophone 900, the same methodology can be applied to other brass and/or woodwind instruments, such as flutes, trumpets, French horns, tubas, sousaphones, oboes, clarinets, etc.

A Virtual Saxophone application may display a fingering chart of every note displayed from a musicXML or midi file as they occur in the corresponding music notation (which may also be extracted from the musicXML or mid file). In the example illustrated in FIG. 9, as each quarter note is played by the musicXML sequencer, the corresponding Saxophone fingering chart is displayed by the Virtual Saxophone. Different (and correct) fingerings may be shown for each Saxophone types (e.g. Tenor, Soprano, Alto, etc . . . ). Note that the Saxophone chart may be updated dynamically in correspondence to a Read Pointer which walks through the music notation (as a user selectable speed). A similar methodology may be implemented for other wind instruments such as Flute, Trumpet, etc . . .

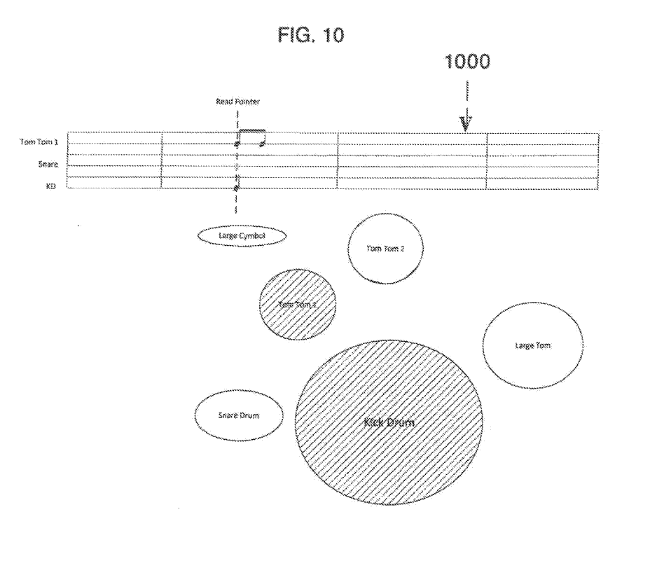

FIG. 10 illustrates an example of a visualization of a virtual drum 1000 that may be displayed on the display unit 110, according to another exemplary embodiment of the present general inventive concept.

Referring to FIG. 10, the transcriber track 240 can also be used to produce the virtual drum 1000 to allow the user to learn how to play the music that was manually transcribed by the user, on a drum.

More specifically, the virtual drum 1000 may be displayed with various types of percussive instruments, including a snare drum, a kick drum, a cymbal, a large tom, a tom tom 1, and a tom tom 2, representing percussion to be played by the user. The various percussive instruments may be highlighted in real-time, or may be slowed down to allow the user to learn the music at a desired tempo.

The number and types of percussive instruments are not limited to FIG. 10, and may include any percussive instruments desired by the user.

A Virtual Drum application may include the specific drums being struck in direct correspondence to the drum notation (derived from the musicXML or midi file). Highlighted drums may change in direct correspondence to the drum chart notation as a read pointer traverses the music notation. In the example illustrated in FIG. 10, both the Kick Drum and the Tom Tom 1 may be highlighted simultaneously in direct correspondence to the values in the notation at the Read Pointer position (which walks through the song at a speed selected by the Beats Per Minute (8 PM) value selected in the application.

Referring to FIGS. 3 and 8-10, each of the virtual guitar 200, piano roll 800, the virtual saxophone 900, and the virtual drum 1000 can be selected by a new top level Tab Menu button in Transcriber Track called “Window,” but is not limited thereto. Under “Window,” the user can select from the Piano Roll 800, the Virtual Saxophone 900, the Virtual Guitar Fret, the Virtual Drums 1000, etc. The user may select the instrument used to perform the transcription on the same screen as the displayed transcription track 240. The application including the Transcriber Track may output a musicXML file after performing pitch detection (and Piano Roll correction), and the Virtual Guitar (or other Virtual instrument) may accept the musicXML as an input via an import function. As such, any desired virtual instrument may be displayed using the transcription track 240.

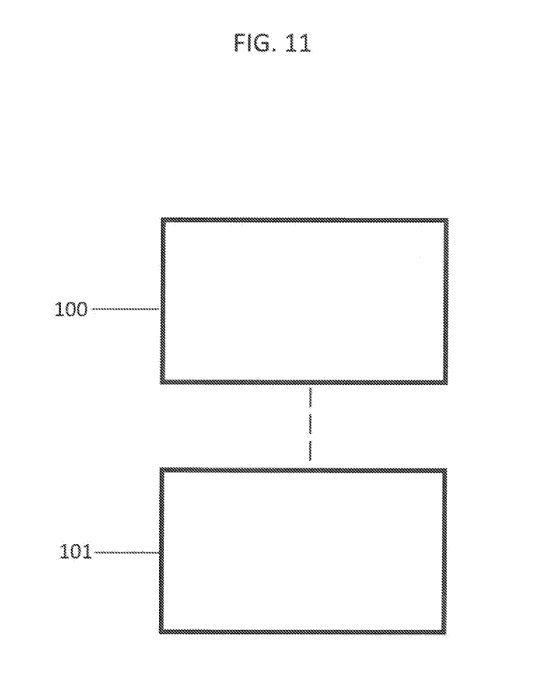

FIG. 11 illustrates the apparatus 100 in communication with a mobile device 101, according to another exemplary embodiment of the present general inventive concept.

Referring to FIG. 11, the apparatus 100 may be the same type of apparatus as described above regarding FIGS. 1 through 10.

The mobile device 101 may be any type of device including a camera having still-recording and video-recording capabilities. For example, the mobile device 101 may be a camera, a video camera, a digital camera, a web camera, a mobile telephone, and a smartphone, but is not limited thereto.

The mobile device 101 may be connected to the apparatus 100 wired or wirelessly. For example, the mobile device 101 may be connected to the apparatus 100 via wired connections, including, but not limited to, USB, FIREWIRE, ETHERNET cable, etc.

Alternatively, the mobile device 101 may be connected to the apparatus 100 via wireless connections, including, but not limited to, ZIGBEE, Z-WAVE, BLUETOOTH, GSM, UMTS, LTE, WLAN, 802.11ac, IoT, RADAR, satellite, WAVEGUIDE, RFID, infrared (IR) wireless communication, Near-Field Communications (NFC), WIFI, WIFI-DIRECT, proximity communications, etc.

A user may use the mobile device 101 to video-record a person while the person is playing an instrument, such as a guitar. As such, the video-recording may be of a guitar player and an actual fingering of fingers of the guitar player, while the guitar player is playing a song on the guitar.

The video-recording may be stored directly onto a storage medium connected to the mobile device as a video file of any type. The storage medium may include, but is not limited to, hard drives, cloud storage, memory cards, RAM, floppy disks, USB flash drives, memory cards, memory sticks, tape cassettes, zip cassettes, computer hard drives, CDs and DVDs.

The video file may be transferred from the mobile device 101 to the apparatus 100 wired or wirelessly. Alternatively, the mobile device 101 may stream the video-recording to the apparatus 100 in real-time, such that the video-recording may be stored directly onto the storage unit 130 of the apparatus 100.

When the apparatus 100 receives the video file or the video-recording from the mobile device 101, the apparatus 100 may subsequently be used to manipulate the video file or the video-recording, hereinafter known as “the video.”

Referring to FIGS. 1, 2, and 11, the processor 140 may control the video to be synchronized with a playback of the transcription track 240. More specifically, the processor 140 may analyze the video by using the software application that may be downloaded and installed on the apparatus 100, to be run by the processor 140. As such, the user may use the input unit 120 to manually input corresponding notes into the transcription track 240 while watching the video on the display unit 110. Alternatively, the transcription track 240 may manually import the notes played on the guitar in the video use screen-capturing technology.

The display unit 110 may also display the video in real-time along with the transcription track 240, when the transcription track 240 is played back with the corresponding transcribed notes. As such, the user may watch the video showing the actual fingering of the fingers of the guitar player playing the song on the guitar, while the transcriber track 240 moves through the corresponding notes, thereby allowing the user to more easily learn how to play the song. Additionally, the user may benefit from watching specific fingering techniques of the guitar player, which are not visible without the video of the guitar player.

Furthermore, the video may be slowed down along with the transcriber track 240 during playback, without affecting a pitch of the song, to make it easier for the user to learn how to properly play the song.

Also, the user may import other previously-recorded videos of musicians playing instruments, such that the apparatus 100 automatically captures corresponding notes played by the musicians, in order to allow for playback of the transcriber track 240 and the previously-recorded videos of the musicians on the display unit 110 of the apparatus 100. In other words, the user may simply download music videos of their favorite bands from sites such as YOUTUBE, etc., and learn their favorite songs using the apparatus 100 and the corresponding transcription application running thereupon.

The present general inventive concept can also be embodied as computer-readable codes on a non-transitory computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to detect, analyze, record, and display audio data, comprising:
an input unit to allow a user to input musical notes corresponding to the audio data;
a processor to analyze the musical notes and to save the musical notes into a file; and
a display unit to display notes corresponding to the musical notes on a virtual instrument.

2. The apparatus of claim 1, wherein the display unit displays a virtual piano roll to allow the user to input the musical notes using the input unit.

3. The apparatus of claim 1, wherein the file is at least one of a midi file and a musicXML file.

4. An apparatus to allow a user to transcribe music from an audio file, the apparatus comprising:
a processor to play music corresponding to the audio file;
a display unit to display a visualization of the music as a playable visual audio track; and
an input unit to allow a user to input musical notes to be displayed on the display unit corresponding to the music as a playable visual transcription track.

5. The apparatus of claim 4, wherein the processor changes the speed of the played music based on a preference of the user.

6. The apparatus of claim 5, wherein the processor plays the playable visual audio track and the playable visual transcription track simultaneously at an original speed.

7. The apparatus of claim 4, wherein musical notes may be input at a slower speed and a synchronization of the music played with respect to the playable audio track at a normal speed is maintained.

8. A method of detecting, analyzing, recording, and displaying audio data, the method comprising:
analyzing data input into an input unit using a processor;
saving the analyzed data; and
displaying musical notes corresponding to the analyzed data on a virtual instrument.
